(19) United States
(12) Patent Application Publication
(10) Pub. No.: US 2002/0138280 A1
(43) Pub. Date: Sep. 26, 2002

(54) Method and system for transcribing recorded information and delivering transcriptions

(76) Inventor: David William Drabo, Gilbert, AZ (US)

Correspondence Address: WEISS & MOY PC, 4204 NORTH BROWN AVENUE, SCOTTSDALE, AZ, 85251, US

(21) Appl. No.: 09/814,599

(22) Filed: Mar. 23, 2001

(51) Int. Cl. G06F 17/60

(52) U.S. Cl. 705/1

(57) ABSTRACT

A method and system for transcribing recorded information and delivering transcriptions reduces the costs associated with traditional transcription service providers. A network is used to transfer sound files from a client computer to a transcription service provider server. A background process on the client computer scans for completed sound files and automatically transmits them to the transcription service provider server. A sound file is assigned to a transcriber and when a transcription document is completed, a notification is sent to the client computer to notify the client that the transcript is available.

### BACKGROUND OF THE INVENTION

1. Field of the Invention

The present invention relates generally to transcription systems, and more specifically, to a method and system for transcribing recorded information and delivering transcriptions.

2. Background of the Invention

Present-day network transcription systems permit doctors, attorneys and other professionals requiring hard-copy or electronic transcripts of recorded verbal information to obtain them from a service provider. Standards such as the Health E Professionals Association (HEPA) standards for medical transcriptions require auditing capabilities

Typically, the recorded verbal information takes the form of tapes that are made with a dictation recorder or other recording device. The tapes are made by a client then coded and delivered to a transcription service provider who creates a hard copy document or electronic document from a recording. The document is then delivered to the client via mail or electronic mail.

Costs associated with present-day transcription systems include the delays associated with the above-described process, mailing costs for the tapes, cost of the tapes and the time consumed in packaging and transferring the tapes to the transcription service provider. Additionally, the transcription service provider must assign the tape to a transcriber and return the document created by the transcriber to the client.

Therefore, it would be desirable to provide a method and system for transcribing recorded information and delivering transcripts that reduces the delay and cost of transferring the information to and from a transcription service provider.

### SUMMARY OF THE INVENTION

The above objective of reducing delay and costs associated with transcribing recorded information and delivering transcripts is achieved in a method and system that transfers recorded information to a service provider over a network. The method transmits a sound file from a client to a transcription service provider via a computer network and delivers a completed transcript to the client via the computer network.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a networked computer system in accordance with a preferred embodiment of the invention.

FIG. 2 is a block diagram depicting functional blocks within computer programs implementing a preferred embodiment of the invention.

FIG. 3 is a flowchart depicting operation a client-side process in accordance with a preferred embodiment of the invention.

FIG. 4 is a flowchart depicting operation a service-side process in accordance with a preferred embodiment of the invention.

### DETAILED DESCRIPTION OF THE PREFERRED EMBODIMENTS

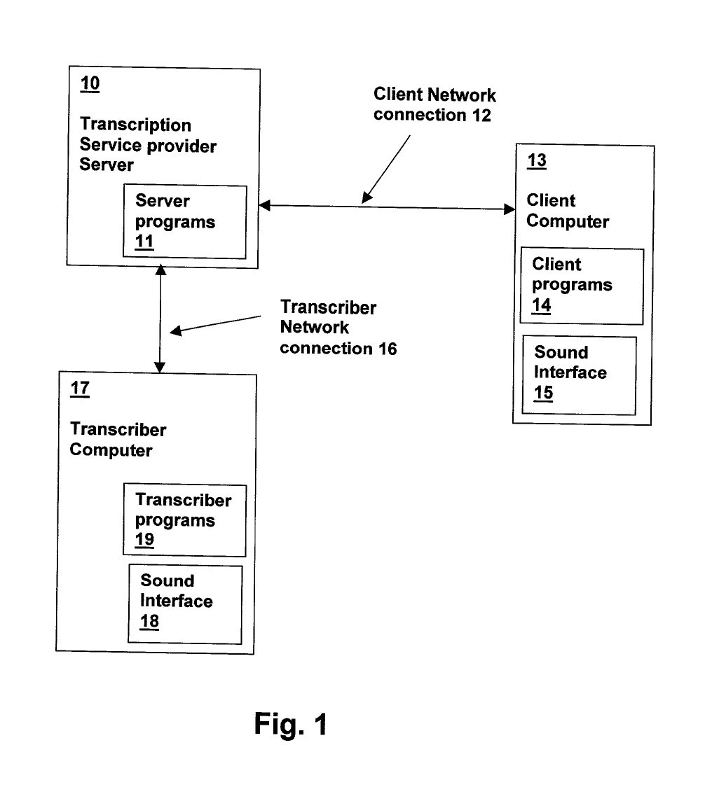

Referring now to the figures and in particular to FIG. 1, a networked computer system in accordance with a preferred embodiment of the present invention is depicted. A client computer 13 is coupled to a transcription service provider server 10 by a client network connection 12. In the preferred embodiment of the invention, network connection 12 is an Internet connection, providing access to world-wide web (WWW) pages hosted by transcription service provider server 10. Client computer 13 has memory and at least one processor, providing for the execution of client programs 14 that are resident in the memory of client computer 13. Client computer also includes a sound interface 15 generally comprising an audio multimedia peripheral card coupled to a peripheral bus within client computer 13. Sound interface 15 is used to record sound files for later transcription, such as medical treatment logs or legal dictation recordings.

A transcription service provider uses transcription service provider server 10 to provide transcription services to clients such as doctors, hospitals, lawyers, etc. Client computer 13 is generally owned by the client and is installed on their premises with client network connection 12 providing access to the Internet via Digital Subscriber Link (DSL) modem, cable modem, Integrated Services Digital Network (ISDN) modem, or plain old telephone system (POTS) modem. Client network connection may include routers, bridges or other devices used to provide local-area network (LAN) services or wide-area network (WAN) services at the client facility. While the illustrative embodiment is depicted with client computer 13 running client programs 14 coupled to transcription service provider server 10 via an Internet connection, the present invention is applicable to anc contemplates other possible embodiments, such as “dumb terminal” connections at the client facility, or other network connections such as a dedicated WAN for enhanced security.

Transcribers provide services to the clients by producing written documents corresponding to recorded information represented in sound files produced by clients. A transcriber uses transcriber computer 17 to receive and play sound files and to operate word-processing software to produce a transcriber document. Transcriber computer 17 is coupled to transcriber network connection 16, which may be an Internet connection similar to that described above for client network connection 12. An Internet connection is particularly useful for transcriber network connection 16 where transcribers are contractors providing services through the transcription service provider. Transcriber network connection 16 may alternatively be a LAN connection co-located with transcription service provider server 10 with employee transcribers located within the same facility. The LAN configuration may be preferable for increased security when transcribers are located conveniently in the transcription service provider facility.

Transcriber computer 17 includes memory and at least one processor for execution of transcriber programs 19 within the memory of transcriber computer 17, and transcriber computer 17 also includes a sound interface 18 to provide playback and possible editing of transcription sound files.

Transcription service provider server 10 manages the operation of the complete transcription system. Server programs 11 executing from a memory by one or more processors within transcription service provider server 10 manage system operation. Security for connections to client computer 13 and transcriber computer 17 is provided by security management within transcription service provider server 10. Transcription service provider server 10 receives sound files from client computer 13 and delivers the sound file to transcriber computer 17. After the transcriber has generated a transcription document, the document is transmitted from transcriber computer 17 to transcription service provider server 10, which can then deliver the document to client computer 13 after the transcriber has released the document. The transcription document may be posted to the transcription service provider server 10 before release if the transcriber has open issues that preclude the actual release of the document to the client.

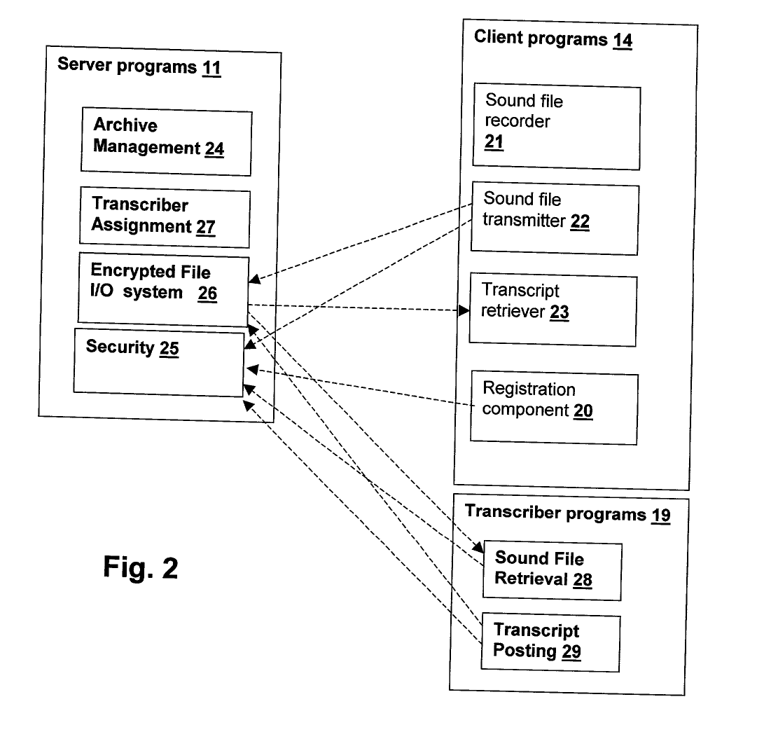

Referring now to FIG. 2, functional blocks within various computer programs implementing a preferred embodiment of the invention are depicted. Server programs 11 include a security module 25, an encrypted file I/O system 26, a transcribed assignment module 27 and an archive management module 24. The security module manages file access and log-in for accesses over client network connection 12 and transcriber network connection 16. Accesses may be made via web pages tailored to the needs of transcribers and clients, or dedicated programs within client computer 13 and transcriber computer 17 may “hide” the file-based nature of the system from the transcribers and clients.

Client programs 14 include a registration component 20, a sound file recorder 21, a sound file transmitter 22 and a transcript retriever 23. Sound file recorder 21 may be an embedded system function such as that included within Windows (a Microsoft, Inc. product) or other operating system, or may be a dedicated hardware interface within client programs 14. Sound file recorder 21 produces a binary file containing recorded information representing the transcription source. An application framework embodying client programs 14 may use the operating system or other component to direct sound interface 15 to record client information via a microphone input coupled to sound interface 15. Sound file transmitter 22 comprises a background process that is started after registration component 20 registers the client with transcription service provider server 10. At registration time, the client selects a directory in which sound files will be stored within client computer 13 (or the directory may be established transparently by client programs 14). The background process of sound file transmitter 22 periodically scans the directory for completed sound files. A completed sound file is detected when the lock status of the sound file is “unlocked.” Sound file transmitter 22 transmits the completed sound file to transcription service provider server 10 as permitted by security module 25. Generally, the sound file will be encrypted before transmission by sound file transmitter 22 for increased security. Secure socket layer (SSL) encryption is used in the preferred embodiment to provide public/private key encryption. The keys may be distributed to the clients via embedded keys within client programs 14, may be generated at registration, or may be distributed by other mechanisms.

When transcription service provider server 10 receives the sound file from client computer 13, the sound file is assigned to a transcriber. Transcriber assignment module 27 maintains a database that links clients to transcribers. Assignment of the sound file to a transcriber may be made automatically and the transcriber may be notified by e-mail or other mechanism such as a notification indicator in a user interface of transcriber programs 19. Alternatively, for a web-based transcriber interface, the sound file may be inserted as a download link within a web page accessible by the transcriber. Sound file retriever 28 receives and decrypts the encoded sound file so that sound interface 18 may be used to playback the recorded information while the transcriber generates the transcription document.

When the transcriber has completed the transcription document, transcript posting 29 encrypts and posts the completed document to transcription service provider server 10 through encrypted file I/O system 26. The completed document is tracked by archive management 24 so that subsequent edits, reads and replacements of the document by either the client or the transcriber are fully auditable and version-controlled. When the transcriber has posted and released the completed document, transcript retriever 23 may retrieve the completed document to client computer 13 permitting the client to view, edit and make hard copies of the transcript. The client may be notified of transcript completion via e-mail, an indicator within an application framework of client programs 14, or as a link appearing on a web page accessible by the client.

Thus, a complete system of sound file recording, transcriber assignment and transcript delivery is achieved in a networked computer system. Transcription service provider server 10 provides other useful features such as database search and retrieval of information for clients, transcribers and the transcription service provider via a searchable database incorporated by archive management 24. Billing and account management, search of transcripts for keys such as medicines within the body of the transcript or client, patient or transcriber within file header information provide easy access to transcripts or sound files containing the search keys. Additionally, transcription service provider server 10 may manage accounts by groups of clients, permitting shared access to the documents, read-only permissions to other clients, or temporary access settings by a client to permit another professional to temporarily access their account, individual transcripts or individual patient records. These features are useful when the client is on vacation, or in instances such as when a patient is being assisted by a doctor in a location far from home and that remote doctor needs to share information with the patient's regular physician. These features also permit physicians to share information with specialists for particular patients.

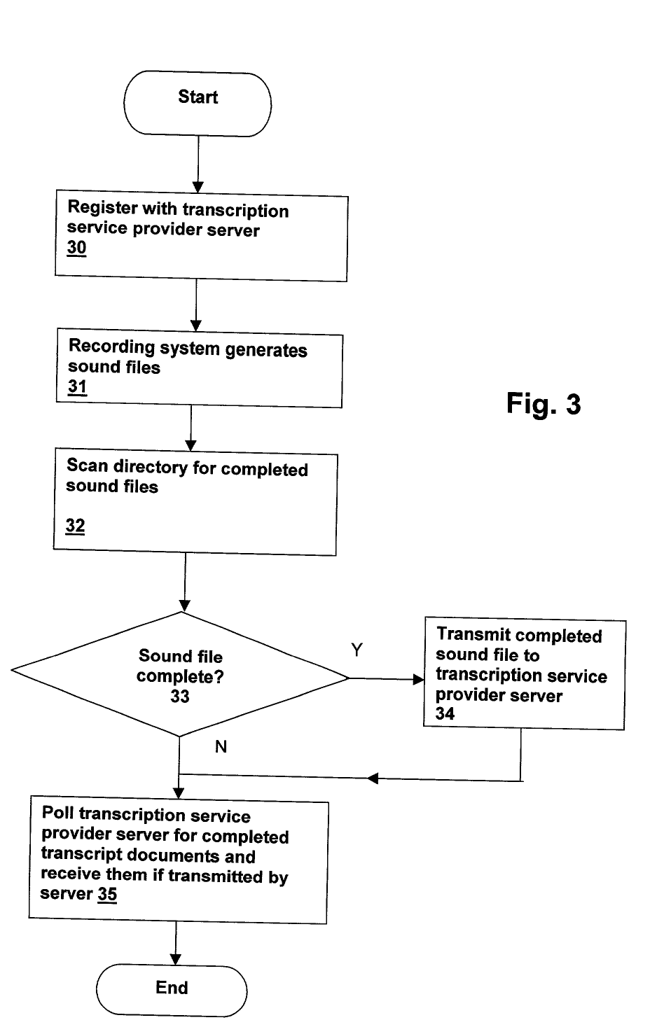

Referring now to FIG. 3, operation of the client-side processes of client programs 14 is depicted in a flowchart. At installation and set-up (or at other intervals as determined by the implementation of server programs 11), the client computer registers with transcription service provider server 10 (step 30). As required, the recording system within client computer 14 generates sound files (step 31). A background process scans the sound file directory for completed sound files (step 32) and if a completed sound file is found (decision 33), the completed sound file is transmitted to transcription service provider server 10 (step 34). At intervals, the transcription service provider server 10 is polled for completed transcript documents and the documents are received when transmitted by transcription service provider server 10 (step 35).

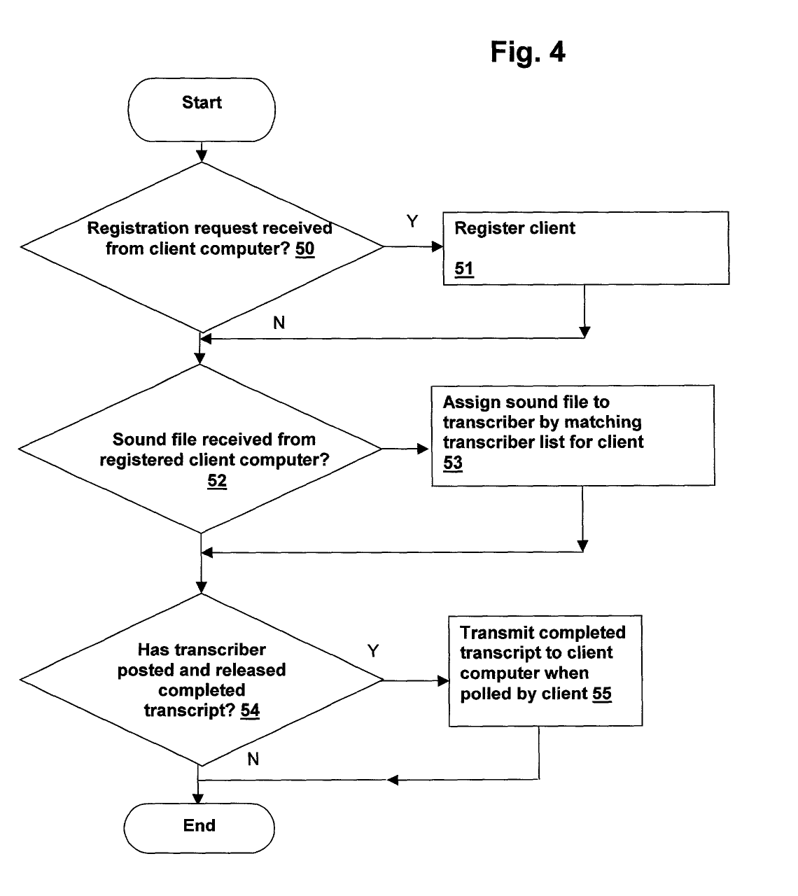

Referring now to FIG. 4, operation of the server-side processes of server programs 11 is depicted in a flowchart. If a registration request is received from client computer 13 (decision 50), the client is registered (step 51). When a sound file is received from a registered client computer (decision 52), the sound file is assigned to a transcriber by matching the transcriber list for that client (step 53). When the transcriber has posted and released a completed transcript (decision 54) the completed transcript is transmitted to the client computer when polled by the client (step 55).

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for transcribing recorded information and delivering transcripts, comprising:
transmitting a sound file representing said recorded information to a transcription service provider server;
receiving said sound file at said transcription service provider server;
transcribing said recorded information to produce a document; and
delivering said document to a client computer.

2. The method of claim 1, further comprising:
recording said recorded information to said sound file within a storage directory on a recording client computer; and
scanning said directory to detect a completed sound file, wherein said transmitting transmits said completed sound file automatically in response to said scanning detecting said completed sound file, and wherein said transmitting transmits said completed sound file to said transcription service provider server.

3. The method of claim 2, wherein said scanning examines a lock status of said sound file and wherein said transmitting is performed in response to determining that said sound file is not locked.

4. The method of claim 1, wherein said delivering is performed by sending a notification from said transcription service provider server to said client computer, whereby a client will be notified to retrieve said document from said transcription service provider server.

5. The method of claim 4, wherein said notification is an e-mail notification and wherein said e-mail notification is performed automatically in response to a release of said document subsequent to completion of said transcribing.

6. The method of claim 1, further comprising registering said client computer with said transcription service provider server, and wherein said transcription service provider server permits said transmitting and performs said delivering only if said registering is complete.

7. The method of claim 1, further comprising automatically assigning said sound file to a transcriber in response to said receiving, and delivering a notification to said transcriber that said sound file has been assigned to said transcriber.

8. The method of claim 7, further comprising matching client information associated with said sound file with a list of clients for said transcriber, and wherein said sound file is assigned in conformity with a result of said matching.

9. The method of claim 1, further comprising maintaining auditing information associated with said document, whereby accesses to said document are recorded.

10. The method of claim 9, further comprising maintaining historical versions of said document so that changes to said document can be tracked.

11. The method of claim 1, further comprising encrypting said sound file to produce an encrypted sound file prior to said transmitting, and wherein said transmitting transmits said encoded sound file.

12. The method of claim 1, further comprising encrypting said document to produce and encrypted document prior to said delivering and wherein said delivering delivers said encrypted document.

13. A system comprising:
a network;
a transcription service provider server coupled to said network, wherein said transcription service provider server includes a memory for storing server program instructions and data, and including a first processor for executing said server program instructions;
a client computer including a second memory for storing client program instructions and data, and including a second processor for executing said server program instructions, wherein said client program instructions transmit a sound file representing recorded information to said transcription service provider server, said server program instructions receive said sound file at said transcription service provider server and deliver a transcribed document representing said sound file to said client computer.

14. The system of claim 13, wherein said client program instructions further record said recorded information to said sound file within a storage directory within said client computer, scan said directory to detect a completed sound file, and transmit said completed sound file automatically in response to detecting said completed sound file.

15. The system of claim 14, wherein said client program instructions examine a lock status of said sound file and transmit said sound file in response to determining that said sound file is not locked.

16. The system of claim 13, wherein said server program instructions deliver said transcribed document by sending a notification from said transcription service provider server to said client computer, whereby a client will be notified to retrieve said transcribed document from said transcription service provider server.

17. The system of claim 16, wherein said notification is an e-mail notification and wherein said e-mail notification is sent automatically in response a transcriber releasing said transcribed document on said transcription service provider server.

18. The system of claim 13, wherein said client program instructions further comprise program instructions for registering said client computer with said transcription service provider server, and wherein said transcription service provider server accepts transmissions and delivers said transcribed document only after said client computer registers with said transcription service provider server.

19. The system of claim 13, wherein said server program instructions automatically assign said sound file to a transcriber in response to receiving said sound file, and deliver a notification to said transcriber that said sound file has been assigned to said transcriber.

20. The system of claim 19, wherein said server program instructions further match client information associated with said sound file with a list of clients for said transcriber, and wherein said sound file is assigned in conformity with a result of said matching.

21. The system of claim 13, wherein said server program instructions further maintain auditing information associated with said transcribed document, whereby accesses to said transcribed document are recorded.

22. The system of claim 21, wherein said server program instructions further maintain historical versions of said transcribed document so that changes to said transcribed document can be tracked.

23. The system of claim 13, wherein said client program instructions further encrypt said sound file to produce an encrypted sound file prior to transmission, and wherein said transmission transmits said encrypted sound file.

24. The system of claim 13, wherein said server program instructions encrypt said transcribed document to produce an encrypted document prior to delivering said transcribed document and wherein said delivering delivers said encrypted document.

25. A computer program product comprising signal-bearing media containing program instructions for execution within a client computer coupled to a computer network including a transcription service provider server, wherein said program instructions comprise program instructions for transmitting a sound file representing recorded information to said transcription service provider server from said client computer and receiving a transcribed document representing said sound file to said client computer.

26. The computer program product of claim 25, wherein said program instructions further record said recorded information to said sound file within a storage directory within said client computer, scan said directory to detect a completed sound file, and transmit said completed sound file automatically in response to detecting said completed sound file.

27. The computer program product of claim 25, wherein said program instructions further comprise program instructions for registering said client computer with said transcription service provider server, whereby said transcription service provider server accepts transmissions and delivers said transcribed document only after said client computer registers with said transcription service provider server.

28. The computer program product of claim 25, wherein said program instructions further encrypt said sound file to produce an encrypted sound file prior to transmission, and wherein said transmission transmits said encrypted sound file.

29. A computer program product comprising signal-bearing media containing program instructions for execution within a transcription service provider server within a computer network including a client computer, wherein said program instructions comprise program instructions for receiving a sound file representing recorded information from said client computer and transmitting a transcribed document representing said sound file to said client computer.

30. The computer program product of claim 29, wherein said program instructions deliver said transcribed document by sending a notification from said transcription service provider server to said client computer, whereby a client will be notified to retrieve said transcribed document from said transcription service provider server.

31. The computer program product of claim 30, wherein said notification is an e-mail notification and wherein said e-mail notification is sent automatically in response to a transcriber releasing said transcribed document on said transcription service provider server.

32. The computer program product of claim 25, wherein said program instructions encrypt said transcribed document to produce an encrypted document prior to delivering said transcribed document and wherein said delivering delivers said encrypted document.

33. The computer program product of claim 25, wherein said program instructions automatically assign said sound file to a transcriber in response to receiving said sound file, and deliver a notification to said transcriber that said sound file has been assigned to said transcriber.

34. The computer program product of claim 25, wherein said program instructions further match client information associated with said sound file with a list of clients for said transcriber, and wherein said sound file is assigned in conformity with a result of said matching.

35. The computer program product of claim 25, wherein said program instructions further maintain auditing information associated with said transcribed document, whereby accesses to said transcribed document are recorded.

36. The computer program product of claim 25, wherein said program instructions further maintain historical versions of said transcribed document so that changes to said transcribed document can be tracked.
